(19) United States
(12) Patent Application Publication
(10) Pub. No.: US 2012/0235086 A1
(43) Pub. Date: Sep. 20, 2012

(54) MINERAL, GRANULATED DESULFURIZING AGENT ON THE BASIS OF CALCIUM HYDROXIDE, METHOD FOR THE PRODUCTION THEREOF AND USE THEREOF

(76) Inventors: Torsten Schlicht, London (GB); Dirk Dombrowski, Empuriabrava (ES)

(21) Appl. No.: 13/499,497

(22) PCT Filed: Sep. 8, 2010
(86) PCT No.: PCT/EP2010/063149

§ 371 Date: Jun. 4, 2012

(30) Foreign Application Priority Data
Oct. 2, 2009 (DE) 10 2009 045 278.8

(51) Int. Cl. B01J 20/04

(52) U.S. Cl. 252/184

(57) ABSTRACT

The invention relates to a mineral desulfurizing agent (10), comprising calcium-based porous granules (12) which comprise a core (14) containing at least 80% by weight of calcium carbonate (CaCO₃) and at least one agglomeration layer (16) enclosing the core (14) and containing calcium hydroxide (Ca(OH)₂), wherein the granules (12) comprise a proportion of calcium hydroxide (Ca(OH)₂) of at least 60% by weight, relative to the total dry weight of the granules (12), have an essentially spherical shape and a BET surface area of at least 8 m²/g. The invention further relates to a method for the production and to the use of a mineral desulfurizing agent.

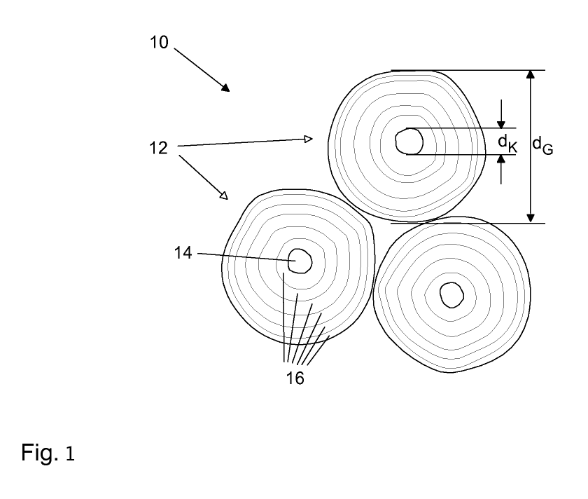

The invention relates to a mineral porous desulfurizing agent that is produced by granulation and can be used, in particular, to separate sulphur oxides from combustion exhaust gases. The invention further relates to a method for the production of said desulfurizing agent and to the use of said desulfurizing agent.

Fossil fuels, such as lignite, peat, coal, petroleum but also fuels that can be used in the internal combustion engines of ships, contain sulphur compounds in varying amounts, which are mainly oxidized to sulphur dioxide, along with a small amount of sulphur trioxide, during combustion of said fuels. For this reason, the exhaust gases produced during combustion of fossil fuels contain up to 10,000 mg SO₂ per standard cubic metre (Nm³) of exhaust gas, wherein the exhaust gases of an internal combustion engine of a ship that is fuelled by residual oils may contain up to 5,000 mg SO²/Nm³. However, exhaust gases containing sulphur oxides are also produced during other thermal processes, such as in waste incineration plant, hazardous waste incineration plant and biomass incineration plant. As sulphur oxides are toxic to the environment and can react with the atmosphere, causing “acid rain”, said sulphur oxides must be removed from the exhaust gases of combustion or incineration processes.

Numerous methods, comprising both wet and dry processes, are used in the field of exhaust gas treatment.

Referring to dry exhaust gas treatment processes, it is known to bring combustion exhaust gases into contact with solid desulfurizing agents, wherein the sulphur oxides react with said desulfurizing agent, forming solid sulphates and sulphites which are retained in the plant. Solid desulfurizing agents used include, in particular, calcium oxide, calcium hydroxide and calcium carbonate, which react with SO₂ and SO₃ at an increased temperature and within different temperature ranges in the presence of oxygen, essentially forming calcium sulphate. The last can be separated in suitable filtering separators, such as electrical precipitators or bag filters comprising textile filtering materials. The reactivity of the desulfurizing agents is defined, in particular, by their particle size, their porosity and their mechanical strength. Some desulfurizing agents are blown directly into the combustion chamber (e.g. limestone). Other desulfurizing agents are reacted with the sulphur oxides of the combustion exhaust gas in a solid-gas reaction that takes place after combustion. The drawback of these so-called entrained-bed processes is the temperature limit of the filtering separators, in particular the bag filters, which cannot be operated at temperatures above 240° C.

Desulfurizing processes for combustion exhaust gases, whose temperatures are usually between 240 and 450° C., require granular-bed filters, which, however, cannot be operated with powdery desulfurizing agents since their use entails technically unacceptable pressure losses.

During dry exhaust gas treatment, basic additives, such as calcium hydroxide and limestone, in powder form are blown into the combustion chamber or the exhaust gas stream and subsequently separated in filtering separators. Often, the exhaust gases are also conditioned by quenching or steaming. WO 92/06772 A1 describes such a dry process where the separation efficiency can be improved by decreasing the temperature of the exhaust gas stream, thus achieving high relative humidities. Nonetheless, such a process will achieve a maximum separation efficiency of 60% at a temperature of 70° C. and a stoichiometric ratio of the basic additive to the pollutant gas of 2:1.

To improve the separation efficiency, DE 37 16 566 A1 proposes to modify the calcium hydroxide during the process of slaking the burnt lime, by adding substances to the slaking water which are intended to increase the reactivity of the calcium hydroxide produced during the slaking process. The additives specified as suitable for said modification are calcium chloride and magnesium chloride. In this context, it is assumed that, due to the fact that calcium chloride tends to absorb water, no water passes to the inside of the calcium hydroxide particles, finally resulting in an increased reactivity of the latter. However, experiments carried out by the present inventors failed to confirm the theory suggested in the above patent document. Contrary to expectations, it has been found that it is precisely the presence of water on the solid surfaces, such as in the form of water vapour sorption layers, which brings about an increased reaction of calcium hydroxide with sulphur dioxide. An additional drawback of the modified calcium hydroxide particles described in DE 37 566 A1 is their highly complex production; as a result, an exhaust gas treatment process using said particles involves high operating costs and has little flexibility in terms of varying exhaust gas composition. Another drawback is that the proposed particles cannot be used in a fixed-bed absorber.

DE 39 15 934 A1 describes an exhaust gas treatment process where surface-active agents are added to the reactive calcium hydroxide. Said agents are characterized by a particularly large surface area, relative to their weight. Activated carbon having an active surface area of 700 m²/g is mentioned as an example. The surface-active agents can be added before, during or after slaking of the calcium hydroxide. The aforesaid modification is aimed at improving separation of heavy metals and dioxines/furanes from the flue gas. However, surface-active substances, as proposed in DE 39 15 934 A1, are only partly involved in the separation of sulphur oxides and cannot be used at temperatures above 300° C. since, in this case, the ignition temperature of activated carbon will be exceeded.

A similar method, which also includes a modification of calcium hydroxide, is known from DE 40 33 417 A1. In this case, additives with a highly porous structure and a correspondingly enlarged reactive surface area are used. As in the method according to DE 39 15 934 A1, the aim is, in particular, to separate heavy metals and organic pollutants by adding substances with a large specific surface area. However, the use of said highly reactive substances in a process for the separation of sulphur oxides is not economical.

EP 0 387 928 A2 proposes a desulfurizing agent that consists of calcium hydroxide with 3 to 10% by weight of lignite ash and is used in pelletized form, wherein the pellets have a diameter of 0.2 to 3 mm, preferably 0.5 to 1 mm, and are fed into the combustion chamber, e.g. of a circulating fluidized bed, at approx. 750 to 950° C. Pellets or granules of said diameter cannot be used in a fixed-bed absorber since the air permeability of such a bed is to low and the pressure loss over the fixed-bed absorber rises to a technically unacceptable level.

Porous mineral granular materials for the adsorption or absorption of liquids and gases are known as well. DE 195 09 747 A1 proposes a granular material whose particle size is between 0.5 and 4 mm, preferably 0.5 and 2 mm, and which is intended to be used as a hygienic animal bedding. EP 0 716 806 A1 also discloses a granular material intended for use as an animal bedding, with particle sizes of <0.5 mm.

Furthermore, DE 198 43 887 B4 discloses a hygienic granular material on the basis of calcium silicate hydrate and bentonite, which granular material comprises pelletized granules with a two-layer structure including a core and a shell or cover, wherein the core mainly comprises calcium silicate hydrate and the cover mainly comprises a mixture of comminuted clay mineral capable of swelling and comminuted calcium silicate hydrate. Such granular materials are not suitable for desulfurizing exhaust gases.

Dosage of the solid desulfurizing agents that bind to sulphur oxides during a gas-solid reaction is problematic since said desulfurizing agents must often be used in a finely dispersed form due to the required reactivity; this, however, entails an unfavourable flow and agglomeration behaviour. For this reason, many attempts have been made to use said desulfurizing agents in a lumpy or pelletized form, which, in many cases, leads to a decreased reactivity; quite often, the active ingredient of the desulfurizing agent must be used in a three- to six-fold stoichiometric excess, relative to the sulphur content of the exhaust gases.

Another drawback is that powdery desulfurizing agents cannot be used in fixed-bed absorbers or moving-bed absorbers since pressure losses would rise to an uneconomical level in a fixed-bed absorber, thus eliminating the advantage of the higher operating temperature of >300° C. and the resulting higher reactivity of the desulfurizing agent, in particular of calcium hydroxide.

The object of the invention is to provide a desulfurizing agent that is suitable for dry exhaust gas treatment, can be used in a lumpy, pelletized or granulated form in granular-bed filters, fixed-bed absorbers and moving-bed absorbers and has a high absorbency and high reactivity in terms of the conversion of sulphur oxides SO_{N}. In addition, said desulfurizing agent should have high mechanical strength, good abrasion resistance and large reactive surface areas as well as high temperature stability of at least up to 500° C. Moreover, said agent should be dimensionally stable and mechanically strong, even after a chemical reaction takes place. Furthermore, the granular material should be non-toxic, environmentally compatible and easy to convey, e.g. by means of pneumatic conveyor systems or chain conveyors. In addition, a method for the production of said desulfurizing agent is to be provided.

The aforesaid objects are achieved by means of a mineral desulfurizing agent, a method for the production thereof and the use thereof having the features set out in the independent claims. Preferred further developments of the invention are described in the independent claims.

The mineral desulfurizing agent according to the invention comprises calcium-based porous granules which comprise a core containing at least 80% by weight of calcium carbonate (CaCO₃) and at least one agglomeration layer enclosing the core and containing calcium hydroxide (Ca(OH)₂). Said granules comprise a proportion of at least 60% by weight of calcium hydroxide (Ca(OH)₂), relative to the total dry weight of the granules. In addition, said granules have an essentially spherical shape and a BET surface area of at least 8 m²/g, in particular 8 to 60 m²/g, preferably 15 to 45 m²/g.

It has surprisingly been found that such a granular material, which essentially consists of calcium hydroxide-based granules, has very good absorption properties in relation to sulphur oxides and maintains its mechanical properties with regard to strength and abrasion resistance after chemical reaction to calcium sulphate. The granules of the granular material have very high stability for use as a bed material as well as good flowability, allowing their use as a filling material in a granular-bed filter, fixed-bed reactor or moving-bed reactor.

For the purpose of the invention, granules making up the granular material (desulfurizing agent) according to the invention mean inherently strong, granular products which are produced by means of a material-applying, agglomerating granulation method rather than a material-removing method such as crushing or milling. Said agglomerating granulation method produces grains whose abrasion-resistant inherent mechanical strength is suitable or very suitable for the intended use. This means, the granules can be conveyed without problems. The manner in which the granules are produced leads to a relatively small particle size range, typically with a Gaussian particle size distribution, wherein the granules have an approximately uniform geometric shape corresponding to a spherical shape and/or approximately spherical shape. In this context, a particle size distribution with diameters in the range from 1 to 20 mm, particularly in the range from 2 to 8 mm, preferably from 3 to 6 mm, has proved to be particularly suitable. Due to the spherical shape, the granules do not have edges susceptible to abrasion, so that there is little abrasion during conveyance or in use.

The mineral desulfurizing agent according to the invention can be produced by a method where a material to be mixed, comprising at least calcium hydroxide (Ca(OH)₂) in the form of a powder and grains containing at least 80% by weight of calcium carbonate (CaCO₃) (the so-called “mother grain”), and water are fed into a granulating mixer or pelletizing mixer, are granulated to produce granules, and the granules produced in this way are dried.

This means, the granules as a whole can be produced of a powder, which contains at least calcium hydroxide, and granular CaCO₃ material and water, obtaining granules with rounded surface contours. For the purpose of the present invention, the equivalent terms “powdery” or “dust-like” refer to very small particle sizes with a normal, production-related particle size distribution. In contrast, “granular” tends to refer to larger particle sizes. Hereinafter, the terms “powder” or “powdery” will mainly be used for the more comminuted fractions. Furthermore, the present document uses the term “material to be mixed” to refer to the dry constituents in their entirety, comprising the calcium hydroxide powder and the calcium carbonate mother grain and optionally additional constituents specified below, i.e. all components except the liquid phase, which preferably consists exclusively of water.

According to a first embodiment of the invention, the powder made up of at least one calcium-based material and the mother grain are fed into a so-called pelletizing mixer or granulating mixer (both terms are equivalent) and combined with water, e.g. by spraying or nozzling, in said mixer while mixing. In an alternative embodiment, the dry material to be mixed or a part thereof is mixed with a part or the entire amount of water before it is fed into the mixer. Granulation or pelletizing then takes place in the pelletizing mixer or granulating mixer. For the purpose of the present invention, the terms “granulation”, “layering granulation”, “agglomeration” or “pelletizing” are treated as equivalents referring to the layer-by-layer formation of the granular material by applying material. Once a granular material with a defined granule size and/or granule size distribution is obtained, said granular material is removed from the pelletizing mixer and dried.

The granulating mixer can be designed, in particular, in the form of a roller drum whose axis of rotation is only slightly inclined relative to the horizontal, or an inclined pan granulator.

The agglomeration principle of said layering granulation will now be explained with reference to a granulating mixer comprising an inclined pan granulator as an example. However, the principle is not different if the granulating mixer used is a roller drum. Once nozzled at a defined dose, the material to be granulated is seized by the rotating pan surface and moved upwards, where it rolls down from the pan surface towards the edge of the pan, either alone or with the aid of a scraper. Due to adhesive forces, the calcium carbonate grains (mother grain), which act as primary particles, first attract particles of the powder fraction across which they are rolling, thus forming primary agglomerates. Said primary agglomerates grow while moving downwards and move transversely to the circular paths described by the points of the pan surface. As a result of the rotational movement of the pan, the aggregates rolling down due to gravity are forced to make an additional rotational movement. At the same time, the granule grows in such a manner that its diameter increases layer by layer. Once it reaches the bottom, the agglomerate, which has already grown a little, is seized by the edge of the pan and moved upwards again, whereupon it rolls down again while another layer of the powder fraction “grows” on the surface of the agglomerate. This process is repeated many times during granulation. During said process, almost all primary particles will finally be incorporated into agglomerates. As the agglomerates roll all the time, they acquire a spherical shape while the structure of the spherical granules becomes more compact. As a result of said compaction, part of the granulation liquid (water) is displaced to the outside of the granules. Practitioners refer to this phenomenon as “sweating” of the so-called green granules and, for the purpose of the invention, this is preferably regarded as a sign that the granulation process is complete. Properly compacted granules are held together by adhesive and cohesive forces, so that the resulting “green strength” is sufficient for damage-free transport to the next process step, the drying process.

According to a preferred embodiment of the method, a calcium hydroxide powder whose particle size distribution is in the range from 1 to 200 μm is used. A particularly suitable calcium hydroxide powder has the following particle size distribution:
>50 to ≦125 μm 3 to 8% by weight
>15 to ≦50 μm 20 to 33% by weight
>5 to ≦15 μm 40 to 57% by weight
≦5 μm 20 to 35% by weight

Preferably, the particle size distribution of the calcium hydroxide powder is as follows:
>50 to ≦125 μm 4 to 7% by weight
>15 to ≦50 μm 23 to 27% by weight
>5 to ≦15 μm 42 to 48% by weight
≦5 μm 23 to 27% by weight

It has been found that calcium hydroxide powder lends itself particularly well to granulation if it is used soon after the slaking process.

The granulation process is particularly smooth if the mother grain has an average particle size of 40 to 150 μm, in particular 45 to 125 μm, preferably 50 to 85 μm. In other words, the mother grain used tends to have a larger particle size than the calcium hydroxide, so that it acts as a kind of nucleus for the granulation process described above.

In addition, it has proved to be particularly suitable that the proportion of the mother grain, relative to the entire dry material to be mixed (corresponding to the proportion of the mother grain relative to the total dry weight of the product), be in the range from 0.05 to 15% by weight, in particular in the range from 0.1 to 10% by weight, preferably in the range from 0.1 to 5% by weight, particularly preferred in the range from 0.1 to 3% by weight. In particularly preferred examples, the proportion is approximately 1% by weight. With regard to calcium carbonate, the mother grain typically has a purity of ≧85% by weight, in particular ≧90% by weight, preferably ≧95% by weight. As described above, the main function of the mother grain is to initiate the agglomeration process, which works particularly well in the ranges specified above in the sense that virtually all the mother grain is processed while the powder material is used up almost entirely and suitable granule diameters are achieved.

The liquid phase used is preferably nothing but water, which is added to the material to be mixed and granulated at defined doses, preferably during mixing. Water can be used in amounts of 10 to 50% by weight, relative to the entire feed material, particularly in the range from 20 to 45% by weight. A preferred proportion of water is 30 to 40% by weight, in particularly preferred examples 32 to 38% by weight, relative to the entire feed material to be granulated in each case. The water can, for example, be added by spraying or nozzling it into the mixer; in this case, granulation in the mixer requires relatively little mixing power. The mixing component parameters, the amount of material to be granulated and, in particular, the proportion of water are adjusted in such a manner that a flowable granular material with relatively good green strength is produced, the three-dimensional shape of which is essentially rounded, i.e. essentially spherical, and which contains water in the amounts specified above.

The drying process can, for example, take place in a fluidized-bed dryer or a belt dryer. The drying conditions (in particular the temperature and duration) are selected in such a manner that the water content after drying is in the range from 2 to 20% by weight, particularly from 3 to 15% by weight, preferably from 4 to 10% by weight and in particularly advantageous examples from 3 to 8% by weight, relative to the total mass of the granules (including the water content) in each case. After drying, the bulk density of the granular material is particularly in the range from 600 to 900 g/l, preferably in the range from 750 to 850 g/l.

The dried product, i.e. the granular material according to the invention, can be microporous with pore diameters smaller than 100 μm or mesoporous with pore diameters in the range from 100 and 500 μm or macroporous with pore diameters above 500 μm. Typically, the pore diameters fall within several of the categories mentioned above.

Once the drying process is complete, the granule diameters are typically in the range from approximately 0.5 to 30 mm, and the desired particle size fraction can be separated in a screening process following said drying process. Advantageously, granules with a particle size distribution including diameters in the range from 1 to 20 mm, particularly in the range from 2 to 8 mm, preferably from 3 to 6 mm, are isolated and used for the intended purpose, for example as a bed, in each case.

To improve the structural integrity of the granules even further, one or more binder(s) can be added to the material to be mixed, so that the binder is contained in the at least one agglomeration layer that has grown on the core (mother grain) in the final granular material. The at least one binder is selected, in particular, from the group of cellulose ethers, in particular of carboxymethyl celluloses, especially of alkaline metal or alkaline-earth metal carboxymethyl celluloses, for example sodium, potassium and calcium carboxymethyl cellulose. Likewise, molasses can be used as a binder, either alone or in combination with other binders. Suitable proportions of the binder are in the range from 0.05 to 2% by weight, in particular from 0.1 to 1% by weight, preferably in the range from 0.2 to 0.5% by weight, relative to the entire dry material to be mixed, so that the final product comprises said proportion relative to the total dry weight of the granular material.

The binder(s) can be admixed to the material to be mixed in the beginning, so that the at least one agglomeration layer in the final granule contains the binder in an essentially homogeneous distribution. In a preferred embodiment, however, the binder is added into the mixer at a later stage of granulation, when the major amount of the powder has already been absorbed by the granules. This secondary granulation process can be suitable for binding residual powder, which may be present in some cases, to the granules. In this variant, granules are produced whose inner agglomeration layers are virtually free from binder and where binder is only contained in the outer agglomeration layers.

It is within the scope of the invention to use other desulfurizing agents in addition to calcium hydroxide (Ca(OH)₂), for example magnesium hydroxide (Mg(OH)₂), calcium oxide (CaO), calcium carbonate (CaCO₃) and/or sodium hydrogen carbonate (NaHCO₃, also referred to as sodium bicarbonate), which can be added to the material to be mixed in powder form before and/or during granulation. Advantageous proportions of said additional desulfurizing agent(s) are in the range of up to 30% by weight, in particular from 1 to 15% by weight, preferably from 5 to 10% by weight, relative to the total dry matter of the granules in each case. Preferably, the sum of all additional desulfurizing agents used does not exceed the aforesaid limits. Furthermore, surface-active agents that bind sulphur oxides by absorption can alternatively or additionally be added, such as hearth furnace coke and/or activated carbon, preferably in amounts of a total of up to 35% by weight, in particular 1 to 15% by weight, preferably from 5 to 10% by weight, again relative to the total dry weight of the granules. Said additional desulfurizing agents and/or surface-active agents are contained in the final granule as a constituent of the agglomeration layer(s) in the aforesaid concentration ranges.

While the aforesaid additional desulfurizing agents and/or surface-active agents are comprised by the present invention, it is preferred that the proportion of calcium hydroxide in the powder fraction (or in the at least one agglomeration layer in the final granular material) be as high as possible. Preferably, the proportion of calcium hydroxide, relative to the total dry mass of the granular material, is 60 to 99.95% by weight, in particular 70 to 99.90% by weight, preferably 80 to 99.90% by weight. In particularly preferred examples, the proportion is 90 to 99.5% by weight, in particular 97 to 99% by weight. In these cases, a calcium hydroxide powder with a degree of purity of at least 85% by weight, in particular at least 90% by weight, preferably at least 94% by weight, can be used.

A granular material produced according to a preferred embodiment of the invention comprises granules consisting of:

| | |
|---|---|
| 82 to 97% by weight | calcium hydroxide |
| 3 to 14% by weight | water bound by adsorption, after drying |
| 0.1 to 3% by weight | calcium carbonate |
| 0 to 1% by weight | carboxymethyl cellulose |

An even more preferred granular material according to the invention is composed of:

| | |
|---|---|
| 90 to 96% by weight | calcium hydroxide |
| 3 to 8% by weight | water bound by adsorption, after drying |
| 0.5 to 1% by weight | calcium carbonate |
| 0 to 0.5% by weight | carboxymethyl cellulose, |

including impurities typically contained in these constituents in traces.

The mineral desulfurizing agent according to the invention, as described above, can advantageously be used to desulfurize the exhaust gases from combustion or incineration processes, in particular exhaust gases produced in internal-combustion engines. The desulfurizing agent according to the invention is characterized by a high absorption of sulphur oxides even at relatively low temperatures; as a result, the exhaust gases can preferably be desulfurized within a broad temperature range from 100 to 900° C., preferably from 130 to 450° C. This corresponds to typical exhaust gas temperatures within the entire operating range of internal-combustion engines, in particular including large diesel engines of ships.

The mineral desulfurizing agent can advantageously also be used to remove hydrogen chloride HCl and/or hydrogen fluoride HF from exhaust gases produced in combustion or incineration processes, wherein said exhaust gas constituents are neutralized. Hydrogen chloride and hydrogen fluoride are produced, for example, in carbon-fuelled boilers or waste incineration plant.

In the context of the aforesaid uses, the desulfurizing agent according to the invention can be used as a bed in granular-bed filters, fixed-bed absorbers or moving-bed absorbers through which the combustion exhaust gases flow, due to its very good mechanical stability, high pressure resistance and little abrasion.

The invention will now be explained in more detail by means of an exemplary embodiment.

(1) Production of the Granular Material

800 g of calcium hydroxide powder (Ca(OH)₂ content 94% by weight), of which 20 to 35% by weight had a particle size of ≦5 μm, 40 to 57% by weight had a particle size of >5 to ≦15 μm, 20 to 33% by weight had a particle size of >15 to ≦50 μm and 3 to 8% by weight had a particle size of >50 to ≦125 μm, was fed into a granulating mixer including a rotary table. This powder fraction, i.e. the material to be mixed, was first continuously sprinkled with water to premix a slurry, wherein the total amount of water added was 500 g. Then, 10 g of mother grain, comprising CaCO₃ particles with a CaCO₃ content of ≧95% by weight and a particle size distribution in the range from 60 to 125 μm, was added to the slurry. Once the resulting agglomerates had absorbed the major part of the material, 2 g sodium carboxymethyl cellulose was added into the mixer, and the process was continued until the entire material had been absorbed by the granules and so-called “sweating” of the granules, i.e. the fact that they begin to shine, indicated that water was displaced from the inside of the agglomerates. Next, the granules were removed from the mixer and dried in a fluidized-bed dryer for 1 h at a temperature of 150° C. The granules obtained in this way had a particle sized distribution in the range from 0.5 to 25 mm. In a subsequent screening process, the particle size fraction of 3 to 6 mm was isolated and used for the following experiments.

The single FIGURE shows a schematic, not-to-scale view of the structure of a typical desulfurizing agent obtained in this way, which, as a whole, is designated with the reference numeral 10, wherein three granules 12 are shown in sectional view as an example. The granules 12 comprise a core 14, exaggerated in size in the FIGURE, which corresponds to the mother grain used, i.e. essentially consists of CaCO₃. This means, the diameter d_{K} of the core 14 corresponds to the average particle size of the mother grain used. The core 14 is surrounded by a plurality of agglomeration layers 16 in a manner resembling essentially concentrically arranged shells, which layers essentially consist of Ca(OH)₃ and can optionally contain additional constituents, in particular binders, such as carboxymethyl cellulose. According to the exemplary embodiment discussed above, the carboxymethyl cellulose is only contained in the outer agglomeration layer(s) 16, increasing the structural integrity and abrasion resistance of the granules 12.

(2) Material Properties of the Granular Material

The three-dimensional shape of the granules 12 produced according to the exemplary embodiment (1) was well rounded and independent of the typical particle size distribution of the calcium hydroxide powder used. The average particle size d_{G} of the granules was approximately 5 mm. A particular advantage of this embodiment was the surface structure of the granules, which consisted of a system of micropores, mesopores and macropores and had an average pore size of approx. 0.03 μm and a BET surface area of approximately 42 m²/g. Table 1 lists some material parameters of the granular material according to the invention produced as in Example (1), compared to commercially available desulfurizing agents.

TABLE 1
Characteristics of granulated desulfurizing agents

| | | | Specific | Median pore |
|---|---|---|---|---|
| Desulfurizing | Composition | Porosity | surface area | size |
| agent | (dry weight) | (%) | (m²/g) | (μm) |
| Limestone | >95% CaCO₃ | 19.3 | 2.9 | 0.54 |
| Comparative | 10-20% Ca(OH)₂ | 27.0 | 7.3 | 0.06 |
| agent A | 80-90% CaCO₃ | | | |
| | 5% others | | | |
| Comparative | 40-45% Ca(OH)₂ | 32.1 | 24.5 | 0.04 |
| agent B | 40-45% CaCO₃ | | | |
| | 10% others | | | |
| Example (1) | ≧93% Ca(OH)₂ | 39.9 | 42.2 | 0.03 |
| | ≧1.2 CaCO₃ | | | |
| | <5.8% others | | | |

(3) Analysis of the Absorption Behaviour of the Granular Material with Regard to SO₂

The granular material according to the invention produced as in Example 1 was tested with regard to its absorption properties, compared to the prior-art materials of Example 2, at 100, 200 and 300° C. in each case. For this purpose, a method has been developed which can be used to compare the relative absorption rates of natural and synthetic materials with each other. In this method, absorbent granular material is exposed to a synthetic flue gas containing SO₂ at selected temperatures. The amount of acid gas absorbed is determined by a combination of simultaneous thermal analysis and an analysis of the gas produced. The materials to be examined were dried and classified. The surface area, density and porosity of each sample were determined, and the chemical composition of each absorbent was calculated by thermal analysis. The characteristic weight losses of CaCO₃ as well as Ca(OH)₂ were measured using a Netzsch STA 449C simultaneous thermal analyzer (TG/DSC), that was coupled to a Bruker Vector 22 FTIR (Fourier Transform Infrared Spectrometer) for the analysis of the gases produced. The amounts of CaCO₃ and Ca(OH)₂ were calculated by comparing the weight loss after heating of each absorbent with the theoretical weight loss for each material. The relative absorption efficiencies for each material were measured using the coupled thermal analysis system. For these measurements, the simultaneous thermal analyzer was operated with a large sample platform that only allows thermogravimetric measurements. The SO₂ concentration was 1800 ppm in dry nitrogen. For the absorption tests, base lines were first defined for the three temperature ranges. The primary infrared absorption band of SO₂ was measured several times per minute. Dry gases were used to minimize overlapping between the absorption bands of water vapour and SO₂. Once the base line had been identified, each sorbent was exposed to SO₂, under the same conditions as for the base line. The difference between the recorded base line and the recording after absorption by the sample was used to calculate the absorption rate of SO₂ by the absorbent. The absorption values shown in the table were obtained by linear approximation (average) to determine a single absorption rate for the material. The results are shown in Table 2. It has surprisingly been found that the granular desulfurizing agent according to the invention has, by far, the highest separation rates with regard to SO₂.

TABLE 2
Data of SO₂ absorption by granulated desulfurizing agents

| | SO₂ absorption | | SO₂ absorption | | SO₂ absorption | |
|---|---|---|---|---|---|---|
| | at 100° C. | | at 200° C. | | at 300° C. | |
| | m_{SO2}/ | m_{SO2}/ | m_{SO2}/ | m_{SO2}/ | m_{SO2}/ | m_{SO2}/ |
| Desulfurizing | m ^{(#)} | m ^{(§)} | m ^{(#)} | m ^{(§)} | m ^{(#)} | m ^{(§)} |
| agent | [g/g] | [g/V] | [g/g] | [g/V] | [g/g] | [g/V] |
| Limestone | 0.000 | 0.000 | 0.000 | 0.000 | 0.004 | 0.004 |
| Comparative | 0.037 | 0.040 | 0.052 | 0.056 | 0.169 | 0.181 |
| agent A | | | | | | |
| Comparative | 0.107 | 0.083 | 0.215 | 0.168 | 0.478 | 0.373 |
| agent B | | | | | | |
| Example (1) | 0.307 | 0.234 | 0.338 | 0.257 | 0.541 | 0.411 |

^{(#)} absorbed amount of SO₂ per g of absorbent
^{(§)} absorbed amount of SO₂ per ml of absorbent

The results show that the mineral desulfurizing agent according to the invention has significantly higher absorption values at all temperatures tested; in addition, absorption is characterized by a very high absorption rate even at the relatively low temperature of 100° C., in contrast to the comparative materials.

Moreover, it has surprisingly been found that an initial peak value, followed by a decreasing absorption rate, can be observed during the absorption of SO₂. This suggests that the reaction rate is controlled by the diffusion of SO₂ through the reaction layer once the surface of the granule is saturated with SO₂. It is therefore advantageous to produce a granular material according to the invention which is characterized by a high degree of porosity and capillarity.

### LIST OF REFERENCE NUMERALS

10 Desulfurizing agent

12 Granule

14 Core

16 Agglomeration layer

d_{K} Diameter of the core/mother grain size

d_{G} Granule grain size

1. A mineral desulfurizing agent (10), comprising calcium-based porous granules (12) which comprise a core (14) containing at least 80% by weight of calcium carbonate (CaCO₃) and at least one agglomeration layer (16) enclosing the core (14) and containing calcium hydroxide (Ca(OH)₂), wherein the granules (12) comprise a proportion of calcium hydroxide (Ca(OH)₂) of at least 60% by weight, relative to the total dry weight of the granules (12), have an essentially spherical shape and a BET surface area of at least 8 m²/g.

2. The desulfurizing agent (10) according to claim 1, wherein the granules (12) have a water content of 2 to 20% by weight relative to the total weight of the granules (12) in each case.

3. The desulfurizing agent (10) according to claim 1, wherein, in addition to calcium hydroxide, the at least one agglomeration layer (16) contains up to 30% by weight of at least one other desulfurizing agent, relative to the total dry weight of the granules (12), selected from magnesium hydroxide (Mg(OH)₂), calcium oxide (CaO), calcium carbonate (CaCO₃) and sodium hydrogen carbonate (NaHCO₃).

4. The desulfurizing agent (10) according to claim 1, wherein the at least one agglomeration layer (16) additionally contains up to 35% by weight of at least one surface-active agent, relative to the total dry weight of the granules (12), selected from hearth furnace coke and/or activated carbon.

5. The desulfurizing agent (10) according to claim 1, wherein the granules (12) comprise a proportion of calcium hydroxide of 60 to 99.95% by weight relative to the total dry weight of the granules (12).

6. The desulfurizing agent (10) according to claim 1, wherein at least one outer agglomeration layer (16) additionally contains at least one binder selected from the group of cellulose ethers and/or molasses.

7. The desulfurizing agent (10) according to claim 1, wherein the granules (12) comprise at least one of micropores with pore diameters smaller than 100 μm, mesopores with pore diameters of 100 to 500 μm and macropores with pore diameters above 500 μm.

8. The desulfurizing agent (10) according to claim 1, wherein the granules (12) have a particle size distribution with diameters (d_{G}) in the range from 1 to 20 mm.

9. The desulfurizing agent (10) according to claim 1, wherein the granules (12) have a BET surface area in the range from 8 to 60 m²/g, particularly in the range from 15 to 45 m²/g.

10. The desulfurizing agent (10) according to claim 1, wherein said desulfurizing agent (10) has a bulk density in the range from 600 to 900 g/l.

11. A method for the production of a mineral desulfurizing agent (10) according to claim 1, wherein a material to be mixed, comprising at least 60% by weight calcium hydroxide (Ca(OH)₂) in the form of a powder relative to the total dry weight of the material to be mixed and a mother grain containing at least 80% by weight of calcium carbonate (CaCO₃), and water are fed into a granulating mixer or pelletizing mixer, are granulated to produce granules (12), and the granules (12) produced in this way are dried.

12. The method according to claim 11, wherein the calcium hydroxide powder has a particle size distribution in the range from 1 to 200 μm, wherein in particular 20 to 35% by weight has a particle size of ≦5 μm, 40 to 57% by weight has a particle size of >5 to ≦15 μm, 20 to 33% by weight has a particle size of >15 to ≦50 μm and 3 to 8% by weight has a particle size of >50 to ≦125 μm.

13. The method according to claim 11, wherein water is used in a proportion of 10 to 50% by weight relative to the dry material to be mixed.

14. The method according to claim 11, wherein the water is added to the material to be mixed in the mixer during mixing, or is premixed with at least one constituent of the material to be mixed before feeding.

15. The method according to claim 11, wherein the drying process takes place in a fluidized-bed dryer or belt dryer.

16. The method according to claim 11, wherein the mother grain has an average particle size (d_{K}) in the range from 40 to 150 μm.

17. The method according to claim 11, wherein a proportion of the mother grain, relative to the dry material to be mixed, is in the range from 0.05 to 15% by weight.

18. (canceled)

19. (canceled)
